(19) United States
(12) Patent Application Publication
(10) Pub. No.: US 2008/0063396 A1
(43) Pub. Date: Mar. 13, 2008

(54) Optical Subchannels From a Single Lightwave Source

(75) Inventors: Jianjun Yu, Stone Mountain, GA (US); Lei Xu, Princeton, NJ (US); Philip Nan Ji, Plainsboro, NJ (US); Ting Wang, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/690,926

(22) Filed: Mar. 26, 2007

Related U.S. Application Data
(60) Provisional application No. 60/825,279, filed on Sep. 12, 2006.

(51) Int. Cl. H04B 10/24

(52) U.S. Cl. 398/42

(57) ABSTRACT

An apparatus includes a generator for obtaining at least two lightwave carriers from a single lightwave source, at least two modulators for selectively varying the lightwave carriers according to respective data signals; and a coupler for combining the modulated lightwave carriers for optical transmission. The generator can be one of an optical carrier suppression or phase modulation. The apparatus can employ a filter for separating the lightwave carriers by a fixed wavelength spacing before selectively varying the lightwave carriers according to the respective data signals. In an exemplary embodiment of the invention, the respective data signals are two 50 Gbit/s differential quadrature phase key DQPSK signals, each 50 Gbit/s DQPSK signal including a first 25 Gbit/s data signal out of phase with a second 25 Gbit/s data signal for selectively varying a respective one of the two lightwave carriers, and the combined modulated lightwave carriers are a 100 Gbit/s DQPSK signal. Preferably, the apparatus includes a modulator for pulse shaping the lightwave carriers.

This non-provisional application claims the benefit of U.S. Provisional Application Ser. No. 60/825,279, filed on Sep. 12, 2006 entitled “100 Gbit/s DQPSK Ethernet Signals Transmission Over 300 km SSMF with Large PMD Tolerance” the contents of which hereby incorporated by reference herein.

### BACKGROUND OF THE INVENTION

The present invention relates generally to optical communications, and more particularly, to 100 Gbit/s Ethernet optical based differential quadrature phase shift key DQPSK transmission.

With the rapid growth of data-centric services, carriers are looking to implement 100 Gbit/s Ethernet in a Metro Area Network (MAN) or access network. There have been 100 Gbit/s Ethernet architectures based on multiplexing for metro networks proposed, and an electrical-time-division multiplexing (ETDM) transmitter has been demonstrated for this system. However, the transmission of 100 Gbit/s signals per channel over a wide-area network, approximately 100 km of fiber length, will result in strong penalties from residual chromatic dispersion (CD) and polarization mode dispersion (PMD), even after practical optical impairment compensation.

Using dispersion compensating fiber (DCF) is the most convenient method of overcoming these limitations. However, the total dispersion of the transmission system can be changed when the Ethernet signals are transmitted from one building to another building with different distance. The temperature variations also affect the dispersion of the transmission system. If the dispersion varies, the dispersion compensation techniques must be flexible.

The solution for these dispersion problems can be either by using a complex system with dynamical dispersion compensation or lowering the bit rate by using wavelength division multiplexing WDM channels. However Ethernet signals based on a WDM system will be difficult to manage. For a new fiber with a length of 100 km and a polarization mode dispersion PMD coefficient of about 0.1 ps/km^{1/2}, the average PMD is about 1 ps. However, use of some old fibers with a PMD coefficient up to 1 ps/km^{1/2} brings the average PMD to about 10 ps.

Moreover, some optical components such as optical couplers, arrayed waveguide gratings AWGs may have a large PMD. Therefore, it is important for 100 Gbit/s signals to have large polarization mode dispersion PMD tolerance. Optical differential quadrature phase shift key (DQPSK) can be used to improve tolerance to chromatic dispersion and PMD. A 100 Gbit/s DQPSK signal transmission over 50 km SMF has been demonstrated.

Accordingly, there is a need for a 100 Gbit/s Ethernet transmission solution that further improves on the group velocity dispersion GVD and polarization mode dispersion PMD tolerances of current 100 Gbit/s proposals.

### SUMMARY OF THE INVENTION

In accordance with the invention, an apparatus includes a generator for obtaining at least two lightwave carriers from a single lightwave source, at least two modulators for selectively varying the lightwave carriers according to respective data signals; and a coupler for combining the modulated lightwave carriers for optical transmission. The generator can be one of an optical carrier suppression or phase modulation. The apparatus can employ a filter for separating the lightwave carriers by fixed wavelength spacing before selectively varying the lightwave carriers according to the respective data signals. In an exemplary embodiment of the invention, the respective data signals are two 50 Gbit/s differential quadrature phase key DQPSK signals, each 50 Gbit/s DQPSK signal including a first 25 Gbit/s data signal out of phase with a second 25 Gbit/s data signal for selectively varying a respective one of the two lightwave carriers, and the combined modulated lightwave carriers are a 100 Gbit/s DQPSK signal. Preferably, the apparatus includes a modulator for pulse shaping the lightwave carriers.

In another aspect of the invention, a method includes obtaining at least two lightwave carriers from a single lightwave source, varying selectively the lightwave carriers according to respective data signals; and combining the modulated lightwave carriers for optical transmission. The at least two lightwave carriers can be obtained from the single lightwave source by optical carrier suppression or phase modulation. In an exemplary embodiment, the respective data signals are two 50 Gbit/s differential quadrature phase key DQPSK signals, each 50 Gbit/s DQPSK signal comprising a first 25 Gbit/s data signal out of phase with a second 25 Gbit/s data signal for selectively varying one of the two lightwave carriers, and the combined modulated lightwave carriers are a 100 Gbit/s signal. Preferably, the method includes pulse shaping the lightwave carriers.

### BRIEF DESCRIPTION OF DRAWINGS

These and other advantages of the invention will be apparent to those of ordinary skill in the art by reference to the following detailed description and the accompanying drawings.

FIG. 1 is diagram of a 100 Gbit/s Ethernet system illustrating signal generation by using low bit rate sub-channels in accordance with the invention.

FIG. 2 is a diagram of an experimental setup for 100 Gbit/s signal generation and transmission over 300 km standard single mode fiber SSMF in accordance with the invention.

FIG. 3A is the optical spectra (0.01 nm) of an original continuous wave CW lightwave and multi-wavelength lightwaves after phase modulation in FIG. 2.

FIG. 3B is the optical spectra (0.01 nm) after the optical coupler OC in FIG. 2 of two lightwaves with a fixed wavelength spacing of 80 GHz selected by an interleaver IL in FIG. 2.

FIG. 3C is the optical spectra (0.01 nm) of a 100 Gbit/s signal before and after transmission with the embodiment of FIG. 2.

FIG. 3D is the optical spectra (0.01 nm) of an up-subchannel and down-subchannel after separation and transmission in the embodiment of FIG. 2.

FIG. 4 is plot of bit error rate and eye diagram (20 ps/div) after transmission over a 300 km single mode fiber in the embodiment of FIG. 2.

FIG. 5 is a plot of received sensitivity at a bit error rate BER of 10⁻¹⁰ as a function of differential group delay DGD, with the eye diagrams (20 ps/div) inserted with their corresponding DGD.

FIG. 6 is a schematic diagram of an alternative embodiment of a 100 Gbit/s Ethernet system employing the inventive single laser source signal generation of low bit rate duobinary encoded sub-channels, rather than the differential quadrature phase shift key encoded signal of FIGS. 1-5.

### DETAILED DESCRIPTION

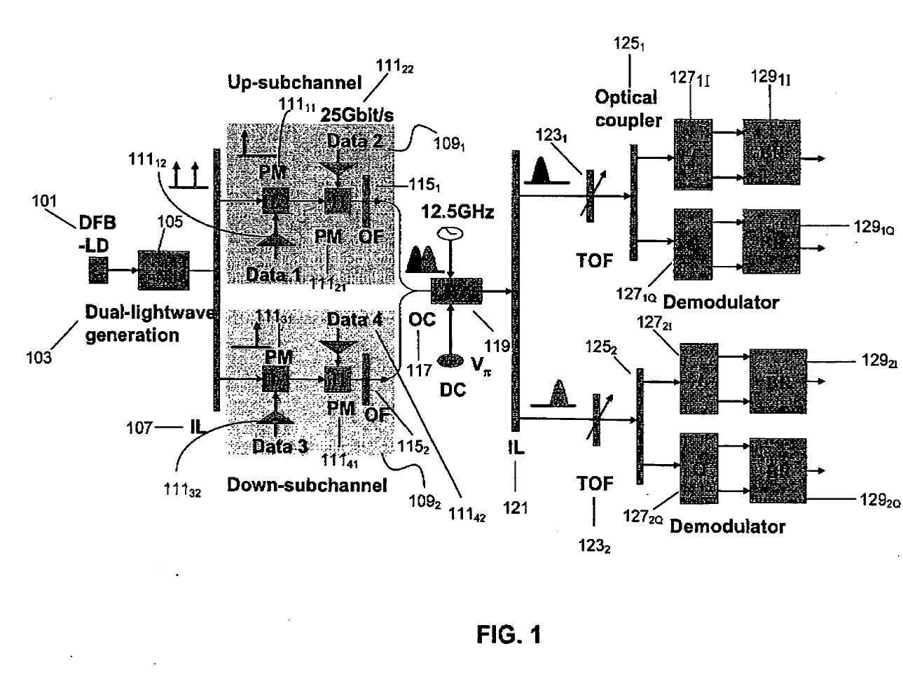

The inventive optical DQPSK based 100 Gbit/s Ethernet transmitter improves on group velocity dispersion GVD and polarization mode dispersion PMD tolerances by using a single laser source to generate two lower bit-rate subchannels. In a preferred embodiment of the invention according to FIG. 1, the 100 Gbit/s Ethernet signal is carried by two 50 Gbit/s DQPSK sub-channels with fixed channel spacing, an up-subchannel 109₁ and down-subchannel 109₂, which are generated by a single laser source. Normally, each differential quadrature phase shift DQPSK transmitter needs a high stability laser source, but the invention needs only one high stability laser source for the two subchannels. The lightwave carriers for the two subchannels are obtained from the same lightwave source 101 after multi-wavelength generation technique. Therefore, the generated light-waves are as stable as the laser source.

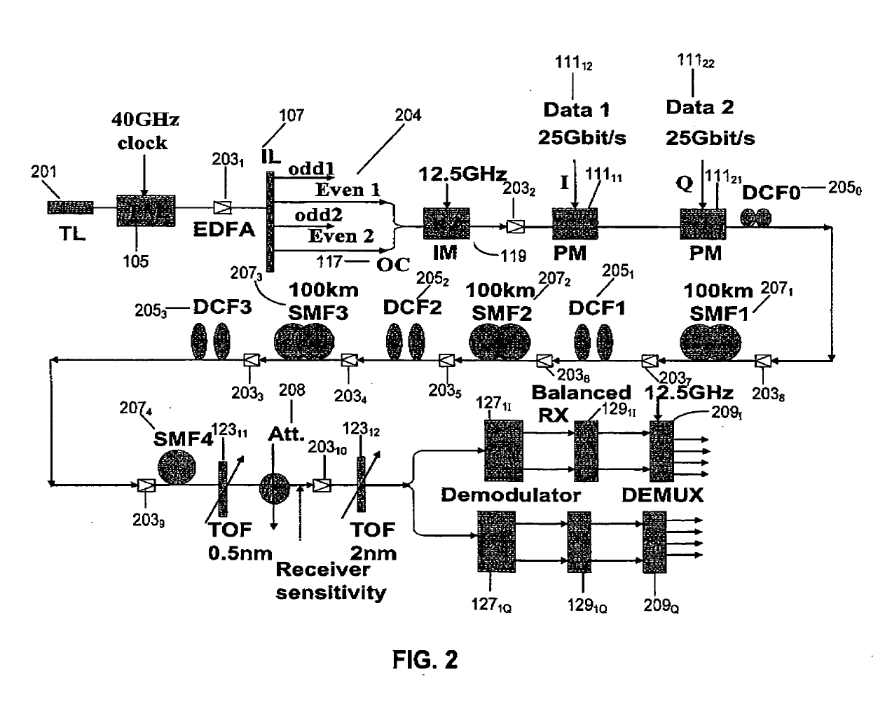

Referring to FIG. 1, there is shown an exemplary embodiment of a 100 Gbit/s Ethernet signal generation and detection system according to the invention. Optical carrier suppression or phase modulation 111₁₁, 111₁₂, 111₂₁, 111₂₂ is used to generate two- or multi-wavelengths with fixed wavelength spacing. A laser source 101, distributed feedback laser diode DFB-LD, is phase modulated 105 with preferably a 40 GHz clock and then interleaved to create odd/even (I and Q) pairs of lightwave carriers 204 (shown in FIG. 2). Each pair of the subchannel lightwave carriers are then quadrature phase modulated 111₁₁, 111₂₁, 111₃₂, 111₄₁ by respective pairs of data streams 111₁₂, 111₂₁, 111₃₂, 111₄₂ at 25 Gbit/s rates. Each I and Q pair are then optically filtered 115₁, 115₂ to reduce the linear crosstalk between the up-subchannel and down-subchannel before they are combined by an optical coupler 117.

With proper optical filtering, the invention achieves two separate light waves with stable wavelength and fixed wavelength spacing. The two sets of 50 Gbit/s DQPSK signals carried by the two lightwaves are generated from a single laser source 101. As the bandwidth for the electrical amplifiers and external phase modulators 111₁₂, 111₂₂, 111₃₂, 111₄₂ is only 25 GHz for the 100 Gbit/s Ethernet signal generation, costs of the whole system are further reduced. Although, the DPSK signal is shown as being generated serially, the DQPSK signal of each sub-channel can be generated either by a parallel or serial configuration. The subsequent optical filtering 1151, 1152 or alternative interleaving (not shown) reduces the linear crosstalk between the up and down subchannels before they are combined by an optical coupler 117. The optical coupler 117 shown is preferably a 3 dB optical coupler.

Return-to-zero RZ modulation of the lower bit-rate subchannels can be accomplished with one intensity modulator 119 driven by an RF clock at 12.5 GHz and biased at half-wave voltage Vₚᵢ. In this case, the frequency of the RF clock can be reduced.

On the receiver side, the up and down subchannels are separated by using interleaving 121, optical filtering 123₁, 123₂ and optical coupling 125₁, 125₂. Then, two pairs of demodulator 127_{1I}/127_{1Q} and 127_{2I}/127_{2Q} are used to demodulate the I and Q portions of the QPSK signals of both the up and down subchannels and convert phase to intensity signals. Balanced receivers 129_{1I}, 129_{1Q}, 129_{2I}, 129_{2Q} are used to detect the optical signals and realize optical/electrical conversion. Finally, the converted electrical signals are de-multiplexed 209_{I}, 209_{Q} (shown in FIG. 2) before the bit error rate BER can be tested.

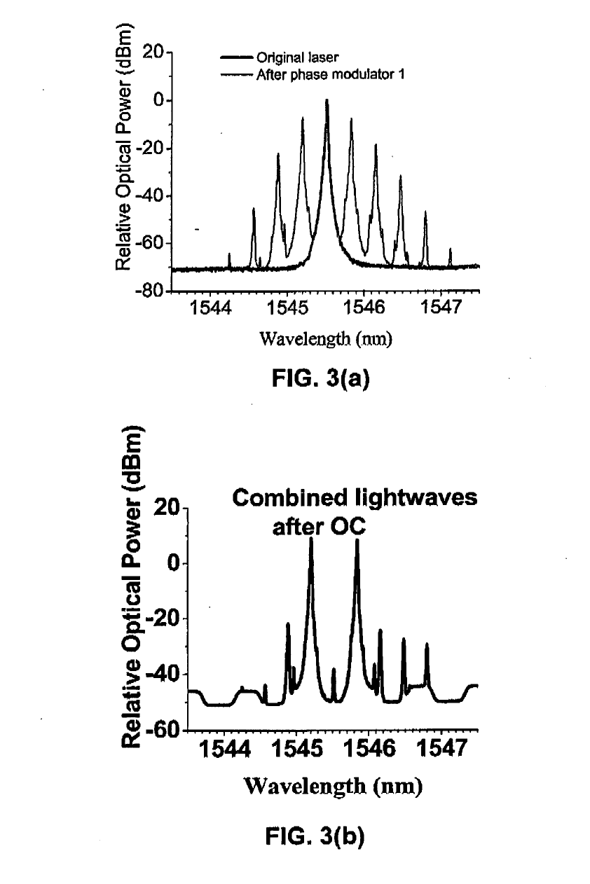

FIG. 2 shows a diagram of an experimental setup for verifying the inventive optical DQPSK transmission with lower bit-rate subchannels derived from a single laser source. The setup of FIG. 2 was modified from FIG. 1 to illustrate performance for the up subchannel with the quadrature I and Q data modulating the separated lightwave carrier. Wavelength spacing between the two I and Q subchannels was increased In order to reduce the linear crosstalk between the two subchannels in this setup. In FIG. 2, a high stability tunable laser 201, preferably at 1545.518 nm was used as a continuous wave CW light source. A phase modulator 105 with low Vₚᵢ (<4V) and small insertion loss (3.5 dB) was employed to generate multi-wavelength source. The optical spectrum after the phase modulator 105, in FIG. 3A, shows that power of the optical carrier and two first-order mode lightwave is large, and wavelength spacing is 40 GHz.

Then an interleaver 107 (50/200 GHz) was used to select the two first-order mode lightwaves, odd1 and even1 204. The optical spectrum after the optical coupler 117, in FIG. 3B, shows that the two lightwave spacing is 80 GHz. The first intensity modulator 119 driven by a 12.5 GHz sinusoidal wave was used to generate an RZ-shape pulse. Then the signals were boosted by an erbium-doped fiber amplifier EDFA. i.e., repeater, before they were modulated by a phase modulatory 111₁₁ (Vₚᵢ=4V) to generate a phase shift of pi/2, followed by another phase modulator 111₂₁ (Vₚᵢ=4V) with a phase shift of pi. Data 1 (data, I) 111₁₂ and Data 2 (data bar, Q) 111₂₂ for driving the phase modulators 111₁₁, 111₂₁ were generated from an electrical 4:1 multiplexer (not shown) combined with four 6.25 Gbit/s PRBS signals with a word length of 2⁷-1. There are 80 bits delay between the data stream I and data stream Q, and the duty cycle of the RZ-QPSK is 33%. Therefore, in this setup, the same 50 Gbit/s DQPSK signals were modulated on the two light-waves.

In the experimental setup, FIG. 2, the path from transmitter to receiver was a combination of 4 single mode fibers SMF1 (207₁), SMF2 (207₂), SMF3 (207₃), SMF4 (207₄), each having an optical path length of 100 km, and dispersion compensating fibers DCFO (205₀), DCF1 (205₁), DCF2 (205₂), DCF3 (205₃). Additional repeaters 203₂, 203₃, 203₄, 203₅, 203₆, 203₇, 203₈, 203₉ and 203₁₀ were used to boost the intensity of optical signals being carried through the SMF and DCF sections and into the receiver.

The DCF0, 205₀, after the Q data stream phase modulation, had a dispersion of −170 ps/nm to de-correlate the up and down subchannel. This dispersion was compensated at the receiver by using 10 km SMF (SMF4). The optical spectrum before the initial DCF0, is shown in FIG. 3C. As noted above, each of the transmission lines consisting of three single mode fiber SMF spans had almost the same span loss and dispersion. The dispersion compensating fiber DCF was used to compensate fully the dispersion of the SMF at the previous stage. Each 100 km SMF span had a dispersion of 17 ps/nm/km, and an attenuation loss of 0.2 dB/km. The total input power into the single mode fibers SMFs was 8 dBm and the input power into dispersion compensating fibers DCFs was 0 dBm, so the nonlinearities in the fiber could be ignored. The optical spectrum after transmission over the 300 km SMF is also shown in FIG. 3C. The OSNR at a bandwidth BW of 0.01 nm after transmission is larger than 25 dB.

A tunable optical filter TOF 123₁₁ with a bandwidth of 0.5 nm was used to choose the up and down channel before one subchannel was attenuated 208. Then a 2 nm tunable optical filter 123₁₂ was used to reduce the amplified spontaneous emission ASE noise before the subchannel was sent to a pair of commercial demodulators 127_{1I}, 127_{1Q}. The demodulator, 127_{1I}, 127_{1Q}, a Mach-Zehnder delay interferometer (MZDI), was used to demodulate each 25 Gbit/s data by adjusting the differential optical phase between two arms to be −pi/4 and pi/4. A balanced receiver 129_{1I}, 129_{1Q} was employed to detect the demodulated signal (I or Q). The output of the balanced receiver was 1:4 de-multiplexed by an electrical de-multiplexer 209_{I}, 209_{Q}, and 6.25 Gbit/s de-multiplexed signals were measured by an error detector.

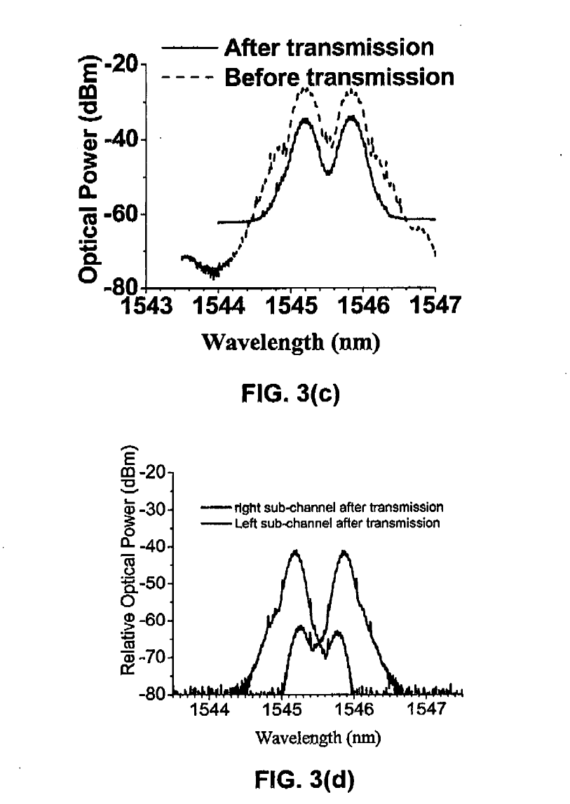

Due to the nature of the DQPSK modulation, the received bit stream was not a pseudorandom pattern as that of the transmitter, and the calculated patterns were used to measure bit error rate BER. The receiver input power is defined as one sub-channel input power to the pre-EDFA. Therefore, for the 100 Gbit/s signal, the receiver sensitivity should be 3 dB lower than the measured value. The power penalty is 0.7 dB after the signals were transmitted over 300 km SMF and full dispersion compensation. The corresponding eye diagram after transmission and balanced receiver is inserted in FIG. 4. It is clearly seen that the eye is well opened. The measured I and Q data shows the receiver sensitivity for them is similar.

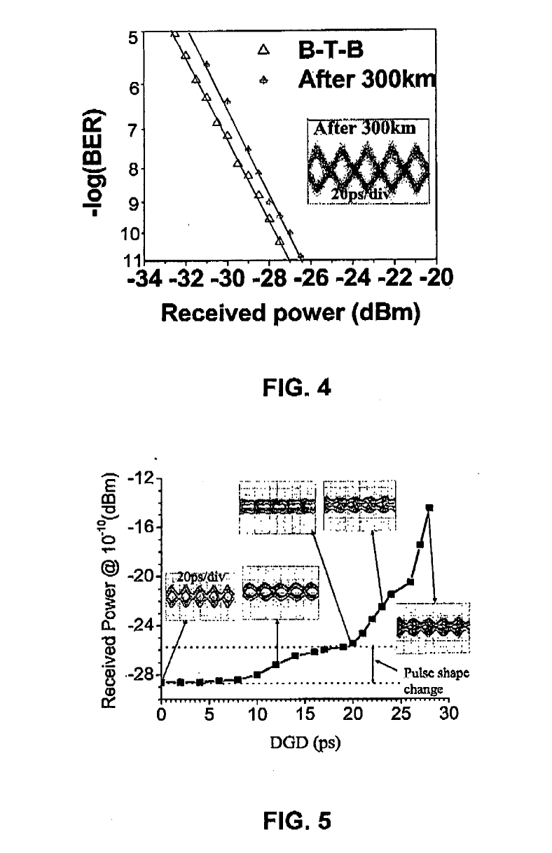

The first order differential group delay DGD tolerance of the 100 Gbit/s Ethernet signal was also measured. The plot of FIG. 5 shows the measured receiver sensitivity at a BER of 10⁻¹⁰ as a function of the DGD. Some typical eye diagrams after balanced detection are inserted in FIG. 5. Increasing the DGD, the RZ shape of DQPSK signal was changed to a non-return-to-zero NRZ shape. Therefore, the receiver sensitivity is degraded. When the DGD is smaller than 20 ps, the degraded receiver sensitivity is mainly caused by the pulse-shape change. The pulse with an RZ shape has 3 dB receiver sensitivity higher than the NRZ-shape signal. The receiver sensitivity was degraded faster after the DGD was larger than 20 ps. The tolerance to polarization mode dispersion PMD for this signal should be larger than 20 ps. It is known that the 100 Gbit/s duobinary DB systems are expected to tolerate a PMD of 5 ps without electronic dispersion compensation EDC, and smaller than 10 ps with EDC. With the inventive teachings, the PMD tolerance can be expected to reach 40 ps with EDC at small receiver power penalties.

In summary, the inventive transmitter employs two 50 Gbit/s DQPSK sub-channels from a single laser source for 100 Gbit/s Ethernet network operation. The experimental results show that this 100 Gbit/s Ethernet signal can tolerate over 20 ps differential group delay DGD and the power penalty is 0.7 dB after transmission over 300 km conventional single mode fiber SMF. A RZ-DQPSK modulation format and two subchannels at a lower bit rate was employed, but only one high stable laser source was used to achieve these high performances.

The present invention has been shown and described in what are considered to be the most practical and preferred embodiments. It is anticipated, however, that departures may be made there from and that obvious modifications will be implemented by those skilled in the art. For example, the preferred embodiment for a 100 Gbit/s Ethernet transmission has been described with the use of a single laser source for generating two lower bit rate subchannels that are differential quadrature phase shift key encoded, as an optimal choice considering cost, complexity and performance, but other multiples of subchannels are possible with different cost and functional efficiencies attainable.

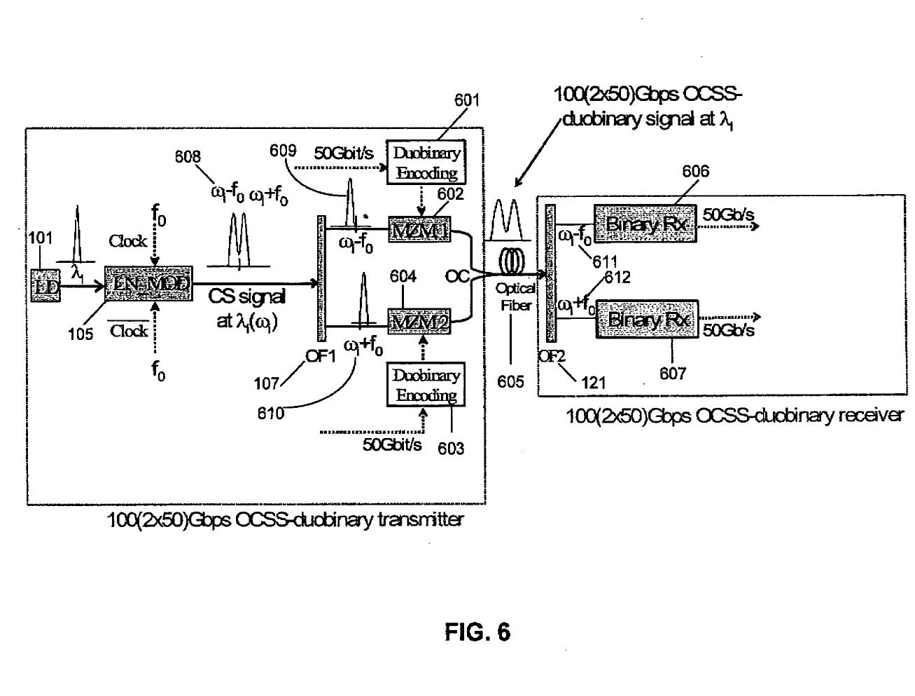

In addition, alternative data encoding techniques may be used with the inventive generation of multiple encoded subchannels from a single laser source. FIG. 6, for example, illustrates a 100 Gbit/s Ethernet system where the carrier signal 608 clocked at f₀ is filtered or interleaved 107 into two sub carriers 609, 610 that are modulated 602, 604 by duobinary encoding streams 601, 603 at 50 Gbit/s each. The out of phase 50 Gbit/s duobinary encoded subchannels are optically coupled and transmitted over a fiber path 605 and then separated by optical filtering 121 of the out of phase subchannels 611, 612 for selective binary receivers 606, 607.

It will be appreciated that those skilled in the art will be able to devise numerous arrangements and variations which, although not explicitly shown or described herein, embody the principles of the invention and are within their spirit and scope.

What is claimed is:

1. An apparatus comprising:
a generator for obtaining at least two lightwave carriers from a single lightwave source,
at least two modulators for selectively varying the lightwave carriers according to respective data signals; and
a coupler for combining the modulated lightwave carriers for optical transmission.

2. The apparatus of claim 1, wherein the respective data signals are two 50 Gbit/s differential quadrature phase key DQPSK signals, each 50 Gbit/s DQPSK signal comprising a first 25 Gbit/s data signal out of phase with a second 25 Gbit/s data signal for selectively varying a respective one of the two lightwave carriers, and the combined modulated lightwave carriers are a 100 Gbit/s DQPSK signal.

3. The apparatus of claim 1, further comprising a modulator for pulse shaping the lightwave carriers for optical transmission over at least a 300 km optical path.

4. The apparatus of claim 1, further comprising a modulator for pulse shaping the combined modulated lightwave carriers.

5. The apparatus of claim 1, wherein the generator comprises an optical carrier suppression.

6. The apparatus of claim 1, wherein the generator comprises a phase modulator.

7. The apparatus of claim 1, further comprising a filter for separating the lightwave carriers by a fixed wavelength spacing before the modulation according to the respective data signals.

8. The apparatus of claim 1, wherein the at least two modulators are differential quadrature phase shift key modulators, each of the modulators varying a respective one of the lightwave carriers.

9. The apparatus of claim 1, wherein the respective data signals are two 50 Gbit/s duobinary encoded signals, each 50 Gbit/s duobinary encoded signal being out of phase with the other 50 Gbit/s duobinary encoded signal, and the combined modulated lightwave carriers are a 100 Gbit/s duobinary signal.

10. A method comprising the steps of:
obtaining at least two lightwave carriers from a single lightwave source,
varying selectively the lightwave carriers according to respective data signals; and
combining the modulated lightwave carriers for optical transmission.

11. The method of claim 10, wherein the respective data signals are two 50 Gbit/s differential quadrature phase key DQPSK signals, each 50 Gbit/s DQPSK signal comprising a first 25 Gbit/s data signal out of phase with a second 25 Gbit/s data signal for selectively varying one of the two lightwave carriers, and the combined modulated lightwave carriers are a 100 Gbit/s signal.

12. The method of claim 10, further comprising the step of pulse shaping the lightwave carriers for optical transmission over at least a 300 km optical path.

13. The method of claim 10, further comprising the step of pulse shaping the combined modulated lightwave carriers.

14. The method of claim 10, wherein the step obtaining at least two lightwave carriers from a single lightwave source comprises optical carrier suppression.

15. The method of claim 10, wherein the step of obtaining at least two lightwave carriers from a single lightwave source comprises a phase modulating of the single lightwave source.

16. The method of claim 10, further comprising the step of separating the lightwave carriers by a fixed wavelength spacing before the step of varying selectively the lightwave carriers according to the respective data signals.

17. The method of claim 10, wherein the step of varying comprises varying the lightwave carriers according to respective differential quadrature phase shift key modulations.

18. The apparatus of claim 1, wherein the respective data signals are two distinct 50 Gbit/s duobinary encoded signals, each 50 Gbit/s duobinary encoded signal being out of phase with the other 50 Gbit/s duobinary encoded signal, and the combined modulated lightwave carriers are a 100 Gbit/s duobinary signal.
